(19) United States
(12) Patent Application Publication
(10) Pub. No.: US 2006/0127702 A1
(43) Pub. Date: Jun. 15, 2006

(54) Magneto-optical recording medium

(75) Inventors: Takahiro Umada, Kawasaki (JP); Koji Matsumoto, Kawasaki (JP); Keiji Shono, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/339,619

(22) Filed: Jan. 26, 2006

Related U.S. Application Data
(63) Continuation of application No. 10/648,248, filed on Aug. 27, 2003.

(30) Foreign Application Priority Data
Sep. 10, 2002 (JP) 2002-264284

(51) Int. Cl. G11B 5/66; G11B 5/33

(52) U.S. Cl. 428/820.5; 428/818; 428/812; 428/820.4

(57) ABSTRACT

In a magneto-optical recording medium having a recording reproduction layer between a substrate and a protective film layer, a recording head disposed at the protective film layer side produces a magnetic field and a light is projected from the recording head side so that information is recorded on the recording reproduction layer. A ratio (Bs2×t2 /Bs1×t1) of a product Bs2×t2 to a product Bs1×t1 is not less than 0.2, where t1 denotes a film thickness of a soft magnetic layer constituting a recording head for supplying the magnetic field to the magneto-optical recording medium, the recording head having a magnetic field generating coil, Bs1 denotes a saturation magnetic flux density of the soft magnetic layer, t2 denotes a film thickness of a soft magnetic layer constituting the magneto-optical recording medium, and Bs2 denotes a saturation magnetic flux density of the soft magnetic layer.

This application claims the benefit under 35 U.S.C. Section 119, of Japanese Application No. 2002-264284, filed Sep. 10, 2002, which is hereby incorporated by reference in its entirety into this application.

This application also claims the benefit under 35 U.S.C. Section 120 of U.S. patent application Ser. No. 10/648,248, entitled MAGNETO-OPTICAL RECORDING MEDIUM, filed Aug. 27, 2003, which is hereby incorporated by reference in its entirety into this application.

### BACKGROUND OF THE INVENTION

1. Field of the Invention

The present invention relates to a magneto-optical recording medium having a recording reproduction layer between a substrate and a protective film layer, wherein a recording head disposed at the protective film layer side produces a magnetic field and a light is projected from the recording head side so that information is recorded on the recording reproduction layer.

2. Description of the Related Art

Hitherto, there is widely used a magneto-optical recording medium such as a magneto-optical disk in which both light and magnetism are used to record information.

Recently, as a higher density recording is required for the magneto-optical recording medium, there are made various proposals for this requirement.

For example, Japanese Patent Application Laid Open Gazette Hei. 9-198731 (reference 1) discloses that there is provided a backing layer made of a soft magnetic material so that a fine CAR (Carrier Noise Ratio) can be obtained even if a short mark is reproduced.

Japanese Patent Application Laid Open Gazette Hei. 11-353725 (reference 2) discloses a layer structure of a magneto-optical recording medium capable of recording with a small external magnetic field.

Japanese Patent Application Laid Open Gazette Hei. 3-105741 (reference 3) discloses that a soft magnetic layer is formed on a substrate.

Japanese Patent Application Laid Open Gazette Hei. 7-320333 (reference 4) also discloses that a magnetic layer is provided (paragraph number 0162, and FIG. 107).

Recently, in order to meet a requirement of a higher density recording, there is proposed a recording system in which a magnetic field and a light are applied from a side of a protective film layer that is thinner as compared with a substrate, instead of the conventional system in which a recording is performed from a side of the substrate.

In case of the recording from the side of the protective film layer, it is possible to increase a numerical aperture of a condenser lens and thereby forming the corresponding small light spot.

In this case, it is merely possible to apply only a relatively weak magnetic field from a recording head so as to have an effect on only a very narrow area, and thus there is actively made a study of a magnetic recording medium having a layer structure capable of obtaining a fine CAR under such a condition.

Here, what records information onto a magneto-optical recording medium is a recording head, and thus when the layer structure of the magneto-optical recording medium is examined, it is also necessary to examine a structure of the recording head.

In an examination of the above-mentioned Japanese Patent references 1 to 4 from this viewpoint, any of the references 1, 2 and 4 relates to a recording from a side of a substrate, and does not consider a recording wherein a magnetic field and a light are applied from a side of a protective film layer.

The reference 3 discloses a recording from a side of a protective film layer as well as a recording from the side of the substrate, and further discloses that a magnetic layer is provided on a magneto-optical recording medium, but fails to recite an association with the structure of the recording head.

### SUMMARY OF THE INVENTION

In view of the foregoing, it is an object of the present invention to provide a magneto-optical recording medium wherein a magnetic field and a light are applied for recording, the magneto-optical recording medium having a structure for generating a fine level of magnetic field.

To achieve the above-mentioned object, the present invention provides a first magneto-optical recording medium including:
a substrate;
a first soft magnetic layer formed on the substrate;
a cured resin layer formed on the first soft magnetic layer having a pre-groove pattern on a surface to a back of the cured resin layer contacting with the first soft magnetic layer;
a recording reproduction layer formed on the cured resin layer; and
a protective film layer formed on the recording reproduction layer,
wherein the magneto-optical recording medium receives an irradiation of a light for recording reproduction and a supply of a magnetic field from a side of the protective film layer, and
wherein a ratio (Bs2×t2/ Bs1×t1) of a product Bs2×t2 to a product Bs1×t1 is not less than 0.2, where t1 denotes a film thickness of a second soft magnetic layer constituting a recording head for supplying the magnetic field to the magneto-optical recording medium, the recording head having a magnetic field generating coil, Bs1 denotes a saturation magnetic flux density of the second soft magnetic layer, t2 denotes a film thickness of the first soft magnetic layer, and Bs2 denotes a saturation magnetic flux density of the first soft magnetic layer.

According to the above-mentioned magneto-optical recording medium, the ratio (Bs2×t2/Bs1×t1) is not less than 0.2. And thus, even if a relatively week magnetic field is applied from the recording head, it is possible to apply a sufficiently strong magnetic field to the recording layer, so that a structure suitable for a high density recording can be provided.

When the second soft magnetic layer of the recording head is divided into a plurality of layers, there is adopted a value where the second soft magnetic layer is formed with a single layer on an equivalent basis. For example, when the second soft magnetic layer of the recording head is divided into two layers, where the respective thickness of the two layers is t11 and t12, and the respective saturation magnetic flux density is Bs11 and Bs12, the above-mentioned product Bs1×t1 is expressed by Bs11×t11+Bs12×t12, that is, Bs1×t1=Bs11×t11+Bs12×t12.

To achieve the above-mentioned object, the present invention provides a second magneto-optical recording medium including:
a substrate;
a first soft magnetic layer formed on the substrate;
a cured resin layer formed on the first soft magnetic layer having a pre-groove pattern on a surface to a back of the cured resin layer contacting with the first soft magnetic layer;
a recording reproduction layer formed on the cured resin layer; and
a protective film layer formed on the recording reproduction layer,
wherein the magneto-optical recording medium receives an irradiation of a light for recording reproduction and a supply of a magnetic field from a side of the protective film layer, and
wherein the first soft magnetic layer is formed by a metallic foil.

In the second magneto-optical recording medium, the first soft magnetic layer is formed with a metallic foil. And thus it is possible to thickly form the thickness to of the first soft magnetic layer. Accordingly, it is possible to enhance a value of the product (Bs2×t2) of the thickness t2 of the first soft magnetic layer and the saturation magnetic flux density Bs2. And thus, even if a relatively week magnetic field is applied from the recording head, it is possible to apply a sufficiently strong magnetic field for the reproduction recording layer, so that a structure suitable for a high density recording can be provided.

In the first magneto-optical recording medium according to the present invention as mentioned above, it is preferable that the first soft magnetic layer is formed with a metallic foil.

In a case where the first soft magnetic layer is formed with a metallic foil in the first magneto-optical recording medium according to the present invention as mentioned above, and in the second magneto-optical recording medium according to the present invention as mentioned above, it is acceptable that the metallic foil constituting the first soft magnetic layer is put on the substrate. Alternatively, it is acceptable that the metallic foil constituting the first soft magnetic layer is formed in a united body with the substrate.

In any of the first magneto-optical recording medium and the second magneto-optical recording medium according to the present invention as mentioned above, it is preferable that the substrate has a preventing structure for preventing the cured resin layer from going out from the first soft magnetic layer when the cured resin layer is in a non-cured state.

In any of the first magneto-optical recording medium and the second magneto-optical recording medium according to the present invention as mentioned above, it is acceptable that the first soft magnetic layer includes a FeNi magnetic material. Alternatively it is acceptable that the first soft magnetic layer includes a CoZrNb magnetic material.

In the first magneto-optical recording medium according to the present invention as mentioned above, it is acceptable that the first soft magnetic layer is coated on the substrate.

### BRIEF DESCRIPTION OF THE DRAWINGS

FIG. 1 is a typical illustration showing a layer structure of a magneto-optical recording medium, as an embodiment common to both a first magneto-optical recording medium of the present invention and a second magneto-optical recording medium of the present invention, and a recording head in a state that a magnetic field and a light are applied to the magneto-optical recording medium.

FIG. 2 is a view useful for understanding a manufacturing method of the magneto-optical recording medium shown in FIG. 1.

FIG. 3 is a graphical representation showing a relation between a soft magnetic layer of the recording head and a soft magnetic layer of the magneto-optical recording medium in the structure shown in FIG. 1.

FIG. 4 is a graph showing CNR (dB) to irradiation light strength.

FIG. 5 is a view useful for understanding a plating process instead of the soft magnetic layer forming process (A) of the manufacturing method shown in FIG. 2.

FIG. 6 is a view useful for understanding a molding process instead of the soft magnetic layer forming process (A1) of the manufacturing method shown in FIG. 2.

FIG. 7 is a view of a molding product produced in the molding process shown in FIG. 6.

### DETAILED DESCRIPTION OF PREFERRED EMBODIMENTS

Hereinafter, there will be described a magneto-optical recording medium according to embodiments of the present invention.

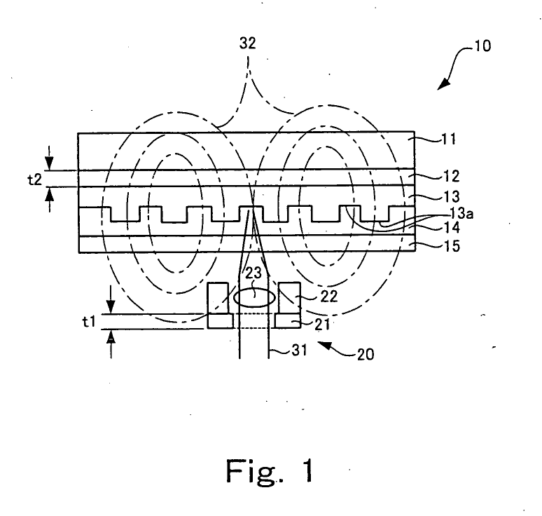

FIG. 1 is a typical illustration showing a layer structure of a magneto-optical recording medium, as an embodiment common to both a first magneto-optical recording medium of the present invention and a second magneto-optical recording medium of the present invention, and a recording head in a state that a magnetic field and a light are applied to the magneto-optical recording medium.

In a magneto-optical recording medium 10 shown in FIG. 1, while a substrate 11 is illustrated on the upper side, a soft magnetic layer 12 having a layer thickness t2 is formed on the substrate 11, and a cured resin layer 13 is formed on the soft magnetic layer 12. According to the present embodiment, the cured resin layer 13 is made of an ultraviolet cured resin that hardens by ultraviolet-light irradiation. On a surface to the back of the cured resin layer 13 contacting with the soft magnetic layer 12, there is formed a pre-groove pattern 13a consisting of recess portions and convex portions extending in a direction of the circumference. Further on the cured resin layer 13, there is formed a recording reproduction layer 14 in which information is recorded and the recorded information is read. On the recording reproduction layer 14, there is formed a protective film layer 15. The recording reproduction layer 14 is formed with a plurality of laminated layers. Details of the recording reproduction layer 14 will be described later.

To record information on the magneto-optical recording medium 10, there is disposed a recording head 20 at the side of the protective film layer 15. The recording head 20 includes a soft magnetic layer 21 having a layer thickness t1, a magnetic field generating coil 22, and a condensing lens 23. Lights 31 generated from a light source (not illustrated) are condensed through the condensing lens 23 on the recording reproduction layer 14. And when the magnetic field generating coil 22 is actuated to generate a magnetic field, the magnetic field has an effect on the recording reproduction layer 14 so that information is recorded on the protective film layer 15.

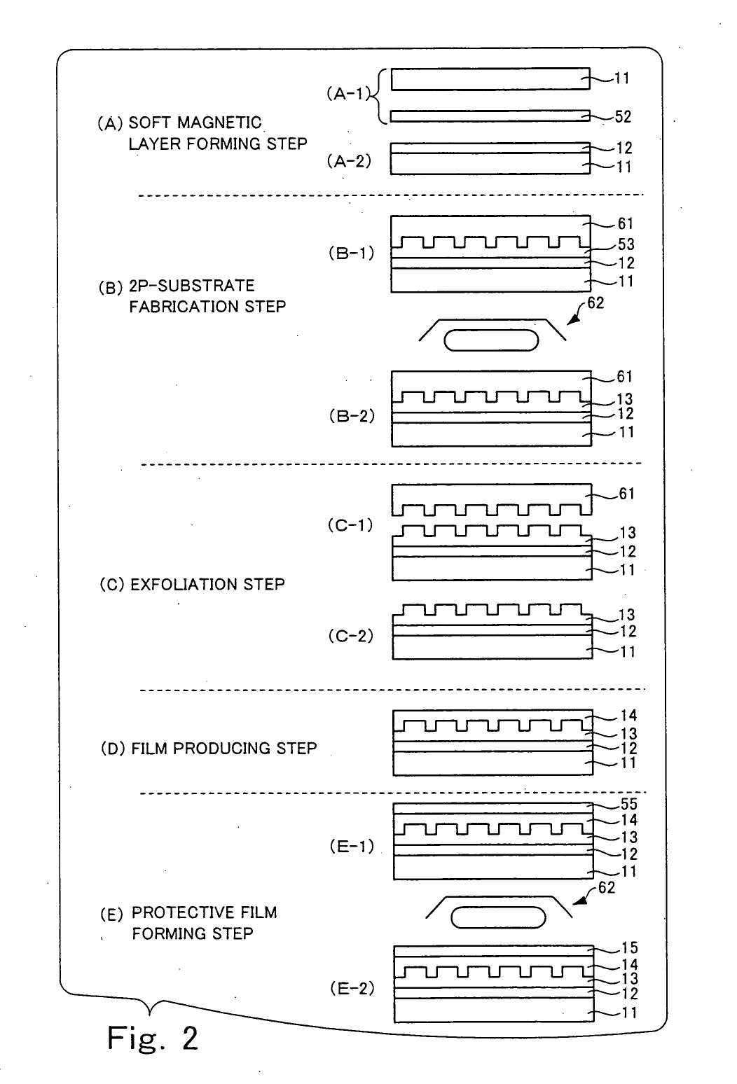

FIG. 2 is a view useful for understanding a manufacturing method of the magneto-optical recording medium shown in FIG. 1.

The magneto-optical recording medium is manufactured via a soft magnetic layer forming step (A), a 2P-substrate fabrication step (B), an exfoliation step (C), a film producing step (D), and a protective film forming step (E). Hereinafter, there will be explained the above-mentioned respective steps.

In the soft magnetic layer forming step (A), an epoxy resin adhesive is applied to the substrate 11, and then a metallic foil 52 is disposed on the substrate 11 to adhere to the substrate 11 by pressurization (A-1). Thus, there is formed on the substrate 11 the soft magnetic layer 12 consisting of the metallic foil 52.

Next, in the 2P-substrate fabrication step (B), an ultraviolet cured resin 53 is applied to the soft magnetic layer 12 consisting of the metallic foil formed on the substrate 11, and a quartz glass stamper 61 having recess and convexity corresponding to the pre-groove pattern is superposed to develop and extend the ultraviolet cured resin 53 by pressurization or a spin scheme (B-1). After completion of the development and extension, an ultraviolet-light irradiation device 62 is used to irradiate an ultraviolet ray from a side of the quartz glass stamper 61. Thus, there is formed the cured resin layer 13 in which the ultraviolet cured resin 53 is cured (B-2).

In the exfoliation step (C), the quartz glass stamper 61 is separated from the cured resin layer 13 after the ultraviolet cure (C-1), so that the cured resin layer 13, which is in a state that the pre-groove is formed, appears on the surface (C-2).

Next, in the film producing step (D), one in which the soft magnetic layer 12 is formed on the substrate 11 and then the cured resin layer 13 is formed on the soft magnetic layer 12, is mounted on a spattering device (not illustrated), as in the step (C-2), so that a recording reproduction layer 14 is formed by a spattering. According to the present embodiment, the recording reproduction layer 14 includes a compound layer of a radiation layer (AlCr), a dielectric layer (SiN), a recording layer (TFC), a reproduction layer (GFC), and a dielectric layer (SiN), which are laminated in the named order from the cured resin layer 13 side, and the spattering device produces those layers in the named order.

In the protective film forming step (E), an ultraviolet cured resin film 55 is formed on the recording reproduction layer 14 produced by the spattering device in accordance with a spin coat scheme (E-1), and the ultraviolet cured resin film 55 is irradiated with ultraviolet ray by the ultraviolet-light irradiation device 62, so that the ultraviolet cured resin film is cured to form the protective film layer 15. According to the present embodiment, the thickness of the protective film layer 15 is 15 μm. This is sufficiently thin as compared with the substrate 11, and the recording head 20 (cf. FIG. 1) can approach the recording reproduction layer 14 by the correspondence.

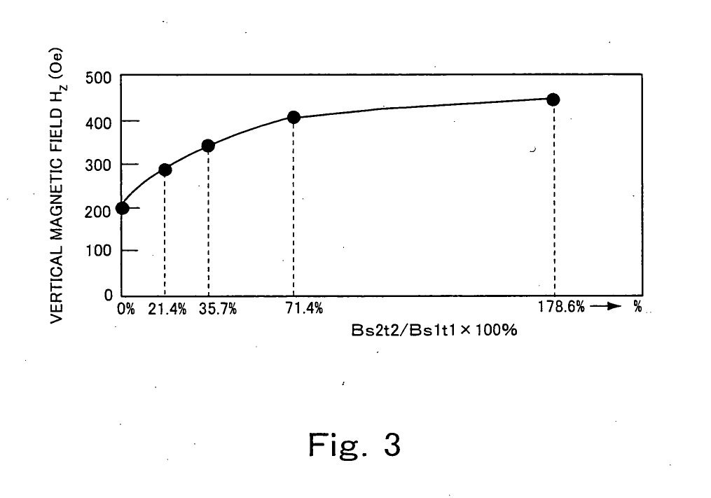

FIG. 3 is a graphical representation showing a relation between a soft magnetic layer of the recording head and a soft magnetic layer of the magneto-optical recording medium in the structure shown in FIG. 1.

A horizontal axis of FIG. 3 denotes Bs2t2/Bs1t1×100%, and a vertical axis denotes a vertical magnetic field (Oe) at a recording point of the recording reproduction layer 14 of the magneto-optical recording medium 10. Where Bs2 denotes a saturation magnetic flux density (T) of the soft magnetic layer 12 constituting the magneto-optical recording medium 10 shown in FIG. 1, t2 denotes a thickness of the soft magnetic layer 12, Bs1 denotes a saturation magnetic flux density (T) of the soft magnetic layer 21 constituting the recording head 20 shown in FIG. 1, and t1 denotes a thickness of the soft magnetic layer 21.

FIG. 3 is a graph representative of a relation between a horizontal axis of Bs2t2/Bs1t1×100% and a vertical axis of a vertical magnetic field (Oe) of the recording reproduction layer 14 of the magneto-optical recording medium 10, where Bs1=0.7T, t1=0.8 μm, Bs2=2.0T, t2≠t1, and a current on the magnetic field generating coil of the recording head =0.35 A.

Generally, it is required for recording information onto a magneto-optical recording medium to generate 300 Oe of the magnetic field. From FIG. 3, it is understood that a provision of 20% or more of the value of Bs2t2/Bs1t1×100% makes it possible to generate 300 Oe of the magnetic field.

Incidentally, it is noted that the thickness t2 of the soft magnetic layer of the magneto-optical recording medium on the point associated with 21.4% in the graph of FIG. 3 is 0.6 μm.

FIG. 4 is a graph showing CNR (dB) to an irradiation light strength.

In FIG. 4, a graph of “the presence of a soft magnetic layer” relates to a magneto-optical recording medium having a soft magnetic layer involved in the conditions described in conjunction with FIG. 3, that is, Bs2=2.0T, t2=0.6 μm, and a graph of “non-soft magnetic layer” relates to a magneto-optical recording medium having the same structure as the magneto-optical recording medium of FIG. 1 except for forming no soft magnetic layer.

In order to perform a recording, there is used a recording head having a soft magnetic layer involved in the conditions described in conjunction with FIG. 3, that is, Bs1=0.7T, t1=8 μm, and the current 0.35 A conducts through a magnetic field generating coil of the recording head to generate a magnetic field, so that the magneto-optical recording medium is rotated at a speed of 15 m/s and a signal is recorded at a recording frequency 25 MHz. A light for recording is of a wavelength λ=400 nm (blue), and the recording is performed with the power Pw (mW) as shown in FIG. 4.

FIG. 4 is a graph of the CNR (dB) thus obtained. In case of “the presence of a soft magnetic layer”, even if the rather week light is concerned, it is possible to obtain a good CNR (dB) such as a CNR of the maximum 50 dB or so. To the contrary, in case of the “non-soft magnetic layer”, only the relatively strong power of light serves to perform a recording and a CNR of the maximum 40 dB or so is merely obtained.

In the soft magnetic layer forming step (A) of the manufacturing method shown in FIG. 2, a metallic foil made of FeNi magnetic material having magnetic characteristic Bs2=1.2T, thickness t2=10 μm, is applied to the substrate to form a magnetic layer, and as other steps the steps (B) to (E) of FIG. 2 are used to manufacture a magneto-optical recording medium, and a signal is recorded. This makes it possible to obtain CNR 50 dB.

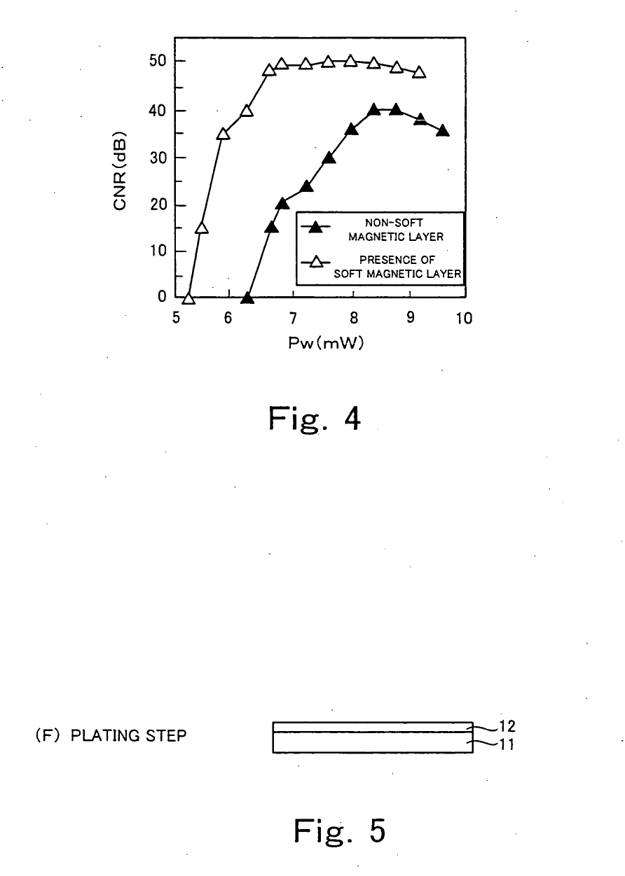

FIG. 5 is a view useful for understanding a plating step instead of the soft magnetic layer forming step (A) of the manufacturing method shown in FIG. 2.

Here, a substrate 11 is preserved in a plating bath consisting of for example FeNi to form a soft magnetic film consisting of FeNi on the substrate 11. It is acceptable that the substrate 11 is preserved in a plating bath consisting of CoZrNb instead of FeNi to form a soft magnetic film consisting of CoZrNb on the substrate 11.

After the formation of the soft magnetic layer on the substrate 11 according to the plating step (F), a magneto-optical recording medium is manufactured via the steps (B) to (E) shown in FIG. 2.

In the plating step (F), there is formed a soft magnetic layer made of FeNi magnetic material having magnetic characteristic Bs2=1.4T, thickness t2=2 μm. Thereafter, as other steps the steps (B) to (E) of FIG. 2 are used to manufacture a magneto-optical recording medium, and a signal is recorded. This makes it possible to obtain the same high CNR as the above.

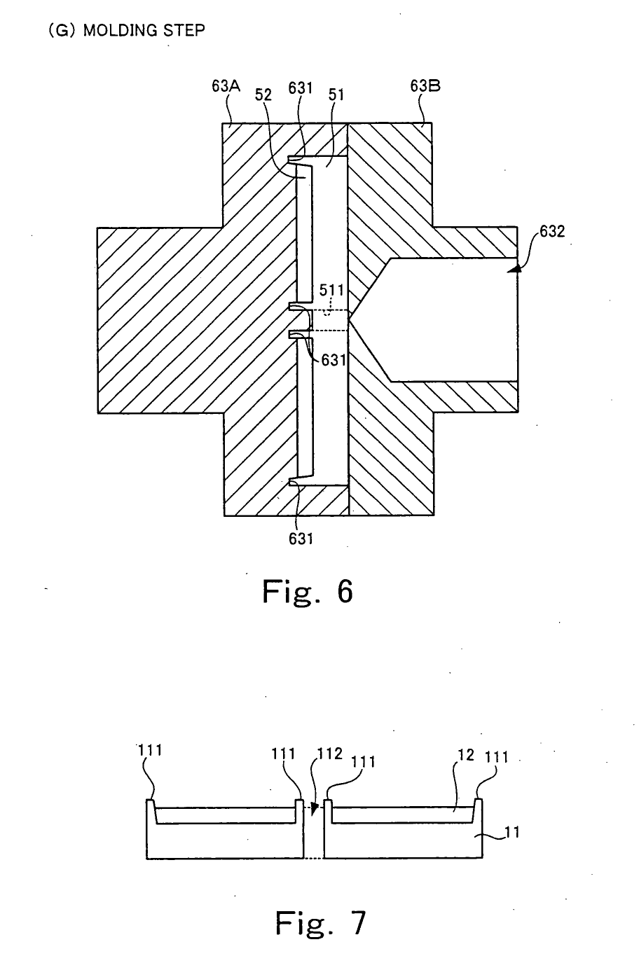

FIG. 6 is a view useful for understanding a molding step instead of the soft magnetic layer forming step (A) of the manufacturing method shown in FIG. 2.

Here, a metallic foil 52 is put on an inside wall of a resin-molding mold 63A and a resin mold 63B is urged to the resin-molding mold 63A, and a resin (here, a polycarbonate resin) is ejected from a resin ejection section 632 into the resin-molding mold 63A to produce a molding product in which the metallic foil 52 and the resin 51 are united with one another.

Here, the resin-molding mold 63A is provided with a circular recess 631 into which the ejected resin flows. And the metallic foil 52 is surrounded by a circular convex portion of the recess 631. An area 511 of the center of the resin 51 is removed to form an aperture.

FIG. 7 is a view of a molding product produced in the molding step shown in FIG. 6.

The molding product includes a substrate 11 made of polycarbonate resin, and a soft magnetic layer 12 made of metallic foil on the substrate 11. On the center of the product is formed a hole 112. On the periphery of the substrate 11 and the periphery of the hole 112 of the center, there are formed circular convex portions 111 with which the soft magnetic layer 12 is surrounded.

After the molding step (G) shown in FIG. 6, basically, the magneto-optical recording medium is created via the step (B) to the step (E) shown in FIG. 2. In the 2P-substrate fabrication step (B), in order to form the cured resin layer 53, a resin having a liquidity before curing is applied to the soft magnetic layer 12. As shown in FIG. 7, surrounding the soft magnetic layer 12 by the convex portions 111 of the substrate 11 may dam the resin by the convex portions 111, so that the resin expands in its entirety without going over. In case of the manufacturing method in which no convex portion 111 is provided, there is a need to provide a step of removing a resin going over when the resin goes over.

While FIG. 6 and FIG. 7 show an example in which the circular convex portions 111 are provided, it is acceptable that circular recess portions (grooves) are formed along the periphery of the substrate 11 and the hole of the center in order to prevent the resin from going out.

In the molding step (G) shown in FIG. 6, a metallic foil made of an FeNi magnetic material having magnetic characteristic Bs2=1.2T, thickness t2=10 μm is used to form a soft magnetic layer by molding as one body with the substrate 11, and thereafter the magneto-optical recording medium is created via steps as shown in the step (B) to the step (E) shown in FIG. 2. When a signal is recorded onto the magneto-optical recording medium thus created, it is possible to obtain a high CNR in a similar fashion to that of the above.

Incidentally, the manufacturing method of the soft magnetic layer is not restricted to the above-mentioned manufacturing method, and it is acceptable that a metallic foil is joined on, for example, an aluminum substrate by a hot rolling processing.

As mentioned above, according to the present invention, it is possible to record minute marks according to a reduction of intensity of the magnetic field generated by a recording head.

While the present invention has been described with reference to the particular illustrative embodiments, it is not to be restricted by those embodiments but only by the appended claims. It is to be appreciated that those skilled in the art can change or modify the embodiments without departing from the scope and spirit of the present invention.

What is claimed is:

1. A magneto-optical recording device, comprising:
a magneto-optical recording medium having
a substrate,
a first soft magnetic layer formed on the substrate,
a cured resin layer having a first surface formed on the first soft magnetic layer and having a pre-groove pattern on a second opposite surface,
a recording reproduction layer formed on the second opposite surface of the cured resin layer,
a protective film layer formed on the recording reproduction layer, and
a recording head having a second soft magnetic layer and a magnetic field generating coil,
wherein the magneto-optical recording medium receives an irradiation of a light from a light source and a supply of a magnetic field from the recording head,
wherein the light source and the head are positioned on a side of the medium, and
wherein a ratio (Bs2×t2/Bs1×t1) of a product Bs2×t2 to a product Bs1×t1 is not less than 0.2, where Bs1 denotes a saturation magnetic flux density of the second soft magnetic layer, t1 denotes a film thickness of the second soft magnetic layer, Bs2 denotes a saturation magnetic flux density of the first soft magnetic layer, and t2 denotes a film thickness of the first soft magnetic layer.

2. A magneto-optical recording device according to claim 1, wherein the first soft magnetic layer is metallic foil.

3. A magneto-optical recording device according to claim 2, wherein the metallic foil is coated directly on the substrate.

4. A magneto-optical recording device according to claim 2, wherein the metallic foil is formed as one body with the substrate.

5. A magneto-optical recording device according to claim 1, wherein the substrate has a structure for preventing the cured resin layer from going out from the first soft magnetic layer when the cured resin layer is in a non-cured state.

6. A magneto-optical recording device according to claim 1, wherein the first soft magnetic layer includes an FeNi magnetic material.

7. A magneto-optical recording device according to claim 1, wherein the first soft magnetic layer includes a CoZrNb magnetic material.

8. A magneto-optical recording device according to claim 1, wherein the first soft magnetic layer is coated directly on the substrate.

9. A magneto-optical recording device according to claim 1, wherein t2 is in the range of 0.2 μm to 10 μm.

10. A magneto-optical recording device according to claim 1, wherein t1 is not equal to t2.

11. A magneto-optical recording device according to claim 1, wherein the soft magnetic layer of the head is parallel to the soft magnetic layer of the medium.
